(19) United States
(12) Patent Application Publication
(10) Pub. No.: US 2024/0228829 A1
(43) Pub. Date: Jul. 11, 2024

(54) AQUEOUS SILICONE RESIN EMULSION AND METHOD OF MAKING

(71) Applicant: Momentive Performance Materials Inc., Niskayuna, NY (US)

(72) Inventors: Bhanu Pratap, Bihar (IN); Vinu Krishnan Appukuttan, Bangalore (IN); Yogesh Tiwary, Bangalore (IN)

(21) Appl. No.: 18/541,077

(22) Filed: Dec. 15, 2023

Related U.S. Application Data
(60) Provisional application No. 63/435,605, filed on Dec. 28, 2022.

(51) Int. Cl. C09D 183/04; C09D 5/02; C09D 7/20; C09D 7/80

(52) U.S. Cl. CPC C09D 183/04; C09D 5/022; C09D 7/20; C09D 7/80

(57) ABSTRACT

A silicone resin emulsion composition, coating compositions comprising such emulsions, and methods of making such emulsions is shown and described herein. The composition comprises a silicone resin, a surfactant, and an emulsion promoting agent. The emulsion promoting agent comprises a hydrophobically modified polyether. The use of the hydrophobically modified polyether along with the surfactant provides a silicone emulsion that is stable.

### CROSS-REFERENCE TO RELATED APPLICATIONS

This application claims priority to and the benefit of U.S. Provisional Application No. 63/435,605 filed on Dec. 28, 2022, the disclosure of which is incorporated herein by reference in its entirety.

### FIELD OF THE INVENTION

The present invention relates to a silicone resin emulsion and method of making the same. In particular, the present invention relates to a silicone resin emulsion comprising an additive to provide a stable aqueous emulsion.

### BACKGROUND

Silicone resins have been used as a binder in paint and coating formulations for some time. Silicone resin emulsions are used in a variety of applications including paints, coatings, mold release agents, peeling release agents, textile treatment agents, and the like. Oil-in-water silicone emulsion compositions can be employed to form a cured film by the removal of water. Silicones are of interest because they can impart desirable properties to a coating including, for example, water repellency, weather resistance, stain resistance, heat resistance, and the like.

Silicone resins are often highly crosslinked through D and T components and, as such, may be characterized by high viscosity. The silicone resins are often provided in aliphatic or aromatic solvents to aid in processing the resins. These solvents are classified as volatile organic compounds (VOCs). As regulation of VOCs becomes more prevalent, there has been a movement to reduce and eliminate such compounds from compositions. In the paint and coatings industry, the interest has been in migrating away from solvent borne compositions to water borne compositions. It can be difficult, however, to employ silicone resins in water borne compositions. Silicones are generally incompatible and/or immiscible with waterborne systems, even with the high shear techniques that are commonly used to form emulsions, making it difficult to prepare emulsions in water borne systems.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a silicone resin emulsion composition. The composition comprises a silicone resin, a surfactant, and an emulsion promoting agent. The emulsion promoting agent comprises a hydrophobically modified polyether. The use of the hydrophobically modified polyether along with the surfactant provides a silicone emulsion that is stable.

In one aspect, provided is a composition comprising: a silicone resin; a surfactant; water; and an emulsion promoting agent, wherein the emulsion promoting agent is selected from the group consisting of a hydrophobically modified polyether, a hydrophobically modified polyether derived copolymer, wherein the hydrophobically modified polyether, and hydrophobically modified polyether derived copolymer have hydrophobic groups at both the terminals.

In one embodiment, the composition consists essentially of the silicone resin, the surfactant, water, and the emulsion promoting agent.

In one embodiment, the emulsion promoting agent is a compound represented by the general formula:

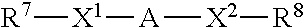

where A is a polyether; X¹ and X² are independently selected from a linker group selected from the group consisting of a polyether, a polyether derived polyurethane and a polyether derived polyester; and R⁷ and R⁸ are independently selected from a monovalent hydrophobic group.

In one embodiment, A is selected from the group consisting of:

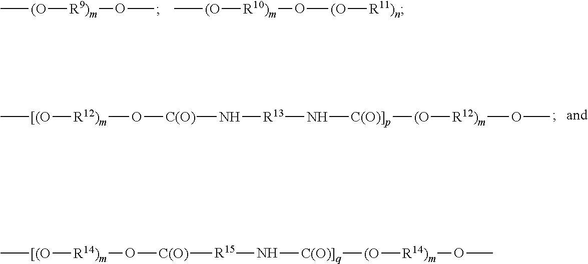

where R⁹, R¹⁰, R¹¹, R¹², R¹³ R¹⁴ and R¹⁵ are each independently a C1-C20 alkylene group; m is 2 or more; n is 2 or more; p is 1 or more; and q is 1 or more.

In one embodiment, A comprises a polyether or a copolymer thereof, wherein the polyether is selected from the group consisting of (—OCH₂-)m, (—OCH₂CH₂-)m, (—OCH(CH₃)CH₂-)m, (—OCH₂CH₂CH₂-)m, (—OCH₂CH₂CH₂CH₂-)m, (—OCH(CH₃)CH₂CH₂-)m, and (—OCH(CH₃)CH(CH₃)-)m, (—OCH₂CH₂CH₂CH₂CH₂-)m

In one embodiment, X¹ and X² are each independently selected from: —O—; —O—C(O)—NH—; —O—C(O)—; —O—C(O)—R¹⁸—; —NH—; —NH—C(O)—; —NH—C(O)—NH—; —N═; —S—; and —S—S—; and R¹⁸ is a C1-C20 divalent hydrocarbon.

In one embodiment, R⁷ and R⁸ are each independently a hydrogen or a hydrophobic group, provided that at least one of R⁷ and R⁸ is a hydrophobic group.

In one embodiment, R⁷ and R⁸ are each a hydrophobic group.

In one embodiment, R⁷ and R⁸ are each independently a C1-C40 alkyl.

In one embodiment, R⁷ and R⁸ are each independently a C8-C25 alkyl.

In one embodiment, the surfactant is a nonionic surfactant.

In one embodiment, the surfactant has a hydrophilic-lipophilic balance of from about 12 to about 30.

In one embodiment, the surfactant is selected from the group consisting of a polyoxyethylene alkyl ether, a polyoxyethylene propylene alkyl ether, a polyoxyethylene alkyl phenyl ether, a fatty alcohol, a polyoxyethylene fatty acid ester, or a combination of two or more thereof.

In one embodiment, the ratio of surfactant to emulsion promoting agent, on a weight basis, is from about 1:200 to about 200:1.

In one embodiment, the silicone resin is an organopolysiloxane selected from the group consisting of a MM, MDM, TD, MT, MDT, MDTQ, MQ, MDQ, and/or MTQ type resin, wherein:

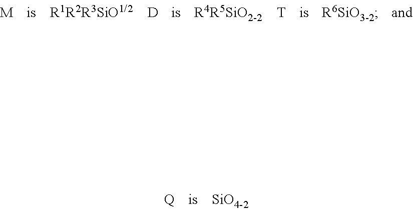

where R¹, R², R³, R⁴, R⁵, and R⁶ are each independently a substituted or an unsubstituted C₁-C30 monovalent hydrocarbon.

In one embodiment, the silicone resin comprises from about 0 to about 50 percent by weight of an M unit; from about 0 to about 90 percent by weight of a D unit; from about 0 to 100 percent of a T unit; and from about 0 to about 60 percent by weight of a Q unit based on the weight of the organopolysiloxane.

In one embodiment, the silicone resin is a DTQ type resin comprising from about 0.5 to about 60 percent by weight of a D unit, and from about 40 to about 99.5 percent by weight of a T unit: and from about 0.1 to about 30 percent by weight of a Q unit.

In one embodiment, the silicone resin is a DT type resin comprising from about 5 to about 50 percent by weight of a D unit, and from about 50 to about 95 percent by weight of a T unit.

In one embodiment, the silicone resin is a DT type resin comprising from about 15 to about 40 percent by weight of a D unit, and from about 60 to about 85 percent by weight of a T unit.

In one embodiment, the silicone resin is T type resin comprising 100 percent by weight of a T unit.

In one embodiment, the silicone resin comprises from about 5 to 40 percent by weight of a T unit of the formula CH₃SiO_{3/2} units, 0 to 35 percent by weight of a D unit of the formula (CH₃)₂SiO_{2/2} units, 15 to 65 percent by weight of a T unit of the formula (C₆H₅)SiO_{3/2}, and 0 to 50 percent by weight of a D unit of the formula (C₆H₅)SiO_{2/2} based on the weight of the polyorganosiloxane.

In one embodiment, the silicone resin comprises from about 0.1 to about 50 percent by weight of a condensable group.

In one embodiment, the silicone resin comprises from about 0.5 to about 20 percent by weight of a condensable group.

In one embodiment, the silicone resin comprises from about 1 to about 7 percent by weight of a condensable group.

In one embodiment, the condensable group is selected from OR¹⁶ or a divalent hydrocarbon radical, OR¹⁷O, where R¹⁶ is independently selected from H or a C1-C10 hydrocarbon radical and R¹⁷ is independently selected from C1-C10 divalent hydrocarbon radical.

In one embodiment, the silicone resin is represented by the formula: (R⁴R⁵SiO_{2/2})ₐ (R₆SiO_{3/2})_{b}

where R⁴, R⁵, and R⁶ are each independently a substituted or unsubstituted C₁-C30 monovalent hydrocarbon; a≥0 and b≥1; a+b≥2.

In one embodiment, the silicone resin comprises from about 1 to about 7 percent by weight of a condensable group.

In one embodiment, the condensable group is selected from OR¹⁶ or a divalent hydrocarbon radical, OR¹⁷O, where R¹⁶ is independently selected from H or a C1-C10 hydrocarbon radical and R¹⁷ is independently selected from C1-C10 divalent hydrocarbon radical.

In one embodiment, the composition is substantially free of a solvent other than water.

In another aspect, provided is a coating comprising the composition of any of the previous embodiments.

In still another aspect, provided is an article comprising the coating, wherein the coating is disposed on a surface of the article.

In yet another aspect, provided is a method of preparing an emulsion, the method comprising: contacting water, a surfactant, an emulsion promoting agent, and a silicone resin to form a mixture, and homogenizing the mixture to form an emulsion, wherein the emulsion promoting agent is selected from the group consisting of a hydrophobically modified polyether and a polyether derived copolymer, wherein the hydrophobically modified polyether has hydrophobic groups at both the terminals.

In a further aspect, provided is an emulsion prepared from the method. In one embodiment, the emulsion is an oil-in-water emulsion.

The following description discloses various illustrative aspects. Some improvements and novel aspects may be expressly identified, while others may be apparent from the description.

### DETAILED DESCRIPTION

Reference will now be made to exemplary embodiments, examples of which are illustrated in the detailed description, embodiments, and examples. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Numerical values and end-points of ranges can be combined to form non-specified ranges.

Provided is an aqueous silicone resin emulsion composition. The composition comprises a water, silicone resin, a surfactant, and an emulsion promoting agent. The emulsion promoting agent comprises hydrophobically modified polyether. The use of the hydrophobically modified polyether in combination with the surfactant has been found to provide a stable silicone emulsion.

The composition of the invention comprises a silicone resin. The silicone resin comprises an organopolysiloxane resin that can include M, D, T, and Q units as is known and understood in the art where:

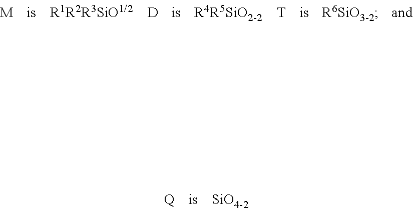

where R¹, R², R³, R⁴, R⁵, and R⁶ are independently selected from a monovalent hydrocarbon radical, OR¹⁶ or a divalent hydrocarbon radical, OR¹⁷O, where R¹⁶ is independently selected from H or a C1-C10 hydrocarbon radical and R¹⁷ is independently selected from C1-C10 divalent hydrocarbon radical. The hydrocarbon radical can be unsubstituted, substituted, linear, branched, cyclic, or acyclic, saturated, or unsaturated. The hydrocarbon radical can be an aliphatic or aromatic hydrocarbon. In one embodiment, R¹, R², R³, R⁴, R⁵, and R⁶ are independently selected from a C1-C30 monovalent hydrocarbon. Examples of suitable hydrocarbon groups include, but are not limited to, methyl, ethyl, n-propyl, isopropyl, n-butyl, isobutyl, see-butyl, t-butyl, n-pentyl, isopentyl, neopentyl, n-hexyl, n-octyl, isooctyl, n-hexenyl, vinyl, allyl, butenyl, butadienyl, cyclopropyl, cyclobutyl, cyclopentyl, cyclohexyl, cyclohexenyl, phenyl, alkylated phenyl groups, hydroxyl, methoxy, ethoxy, isopropoxy, n-butyloxy, t-butyloxy, isobutyloxy, n-pentoxy, neopentoxy, n-hexoxy, n-heptoxy, n-octoxy, phenoxy, vinyloxy, allyloxy, 2-methoxyethoxy, 2-ethoxyethoxy, 2-aminoethoxy, methylamino, dimethylamino, benzylamino, ethanolamino, and diethanolamino groups. In one embodiment, R¹, R², R³, R⁴, R⁵, and R⁶ are methyl. In one embodiment, R¹, R², R³, R⁴, R⁵, and R⁶ are independently selected from methyl and phenyl. In one embodiment, the silicone resin includes M, D, and/or T units where R¹, R², R³, R⁴, R⁵, and R⁶ are methyl, and in some other embodiments, the silicone resin includes M, D, and/or T units where R¹, R², R³, R⁴, R⁵, and R⁶ are phenyl.

Some examples of classes of polysiloxane backbone structures include the MM, MDM, TD, MT, MDT, MDTQ, MQ, MDQ, and MTQ classes of polysiloxanes, and combinations of two or more thereof. In one embodiment, the organopolysiloxane resin can contain from about 0 to about 50 percent, from about 0 to about 40 percent, or from about 0 to about 25 percent by weight of an M unit; from about 0 to about 90 percent, from about 0 to about 60 percent, or from about 0 to about 40 percent by weight of a D unit; from about 0 to 100 percent, 0 to about 90 percent, 0 to about 75 percent, or 0 to about 50 percent by weight of a T unit; and from about 0 to about 60 percent, 0 to about 50 percent, or 0 to about 25 percent by weight of a Q unit based on the weight of the polyorganosiloxane. It will be appreciated that the total weight percent of the respective units in the polyorganosiloxane will add up to 100 percent.

In one embodiment, the polyorganosiloxane resin is a DTQ type resin comprising from about 0.5 to about 60 percent, from about 1 to about 50 percent, or about 5 to about 30 percent by weight of a D unit, and from about 40 to about 99.5 percent, from about 50 to about 95 percent, or from about 60 to about 80 percent by weight of a T unit, and from about 0.1 to about 30 percent, from about 1 to about 25 percent, or from about 5 to about 20 percent by weight of a Q unit based on the total weight of the polyorganosiloxane.

In one embodiment the polyorganosiloxane is a DT type resin. In one embodiment, a DT type resin has from about 0.5 to about 60 percent by weight, about 1 to about 50 percent by weight, or about 5 to about 30 percent by weight of a D unit, and from about 40 to about 99.5 percent, from about 50 to about 95 percent, or from about 60 to about 80 percent by weight of a T unit based on the total weight of the polyorganosiloxane. In one embodiment, the polyorganosiloxane is a DT type resin comprising from about 5 to about 50 percent, about 10 to about 45 percent, or about 15 to about 40 percent by weight of a D unit, and from about 50 to about 95 percent, from about 55 to about 90 percent, or from about 60 to about 85 percent by weight of a T unit based on the total weight of the polyorganosiloxane. In one embodiment, the organopolysiloxane is a DT type resin comprising 5 to 40 percent by weight of a T unit of the formula CH₃SiO_{3/2} units, 0 to 35 percent by weight of a D unit of the formula (CH₃)₂SiO_{2/2} units, 15 to 65 percent by weight of a T unit of the formula (C₆H₅)SiO_{3/2}, and 0 to 50 percent by weight of a D unit of the formula (C₆H₅)SiO_{2/2} units based on the total weight of the polyorganosiloxane, wherein there is present, approximately, 1.0 to 1.8 organic radicals for each silicone atom.

In embodiments, the polyorganosiloxane units optionally contain a condensable group. The condensable group can be selected from OR¹⁶ group or OR¹⁷O group and optionally one or more of R¹, R², R³, R⁴, R⁵, and R⁶ is selected from OR¹⁶ or OR¹⁷O where R¹⁶ and R¹⁷ is as described above. In one embodiment, R¹⁶ is H. In one embodiment, R¹⁶ is a C1-C10 monovalent hydrocarbon. In one embodiment, R¹⁷ is a C1-C10 divalent hydrocarbon. In one embodiment, the polyorganosiloxane comprises from about 0.1 percent to about 50 percent by weight, from about 0.5 percent to about 20 percent, or from about 1 percent to about 7 percent by weight of a condensable group based on the weight of the polyorganosiloxane.

The silicone resin is present in an amount of from about 10 wt. % to about 90 wt. %, from about 20 wt. % to about 80 wt. %, or from about 30 wt. % to about 60 wt. %, or from about 40 wt. % to about 50 wt. % based on the total weight of the composition.

Some examples of suitable silicone resins that may be employed in the composition include, but are not limited to, silicone resins available from Momentive Performance Materials Inc. such as, but not limited to, those sold under the tradenames SR882M, TSR1452, TSR117, TSR127B, TSR144, SR355, CoatOSil M120XB, and the like.

The composition includes an emulsion promoting agent. In one aspect, the emulsion promoting agent is selected from the group consisting of a hydrophobically modified polyether, a hydrophobically modified polyether derived copolymer, wherein the hydrophobically modified polyether, and hydrophobically modified polyether derived copolymer have hydrophobic groups at both the terminals. hydrophobically modified polyether. The hydrophobically modified polyether has been found to function as an emulsion promoting agent. In one embodiment, the hydrophobically modified polyether is an ABA polyether based block-type copolymer modified at the terminal ends with a hydrophobic group.

In one embodiment, the emulsion promoting agent is of the formula:

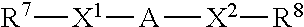

where A is a polyether based unit; X¹ and X² are linker group, and R⁷ and R⁸ are independently selected from a hydrophobic group.

In one or more embodiments, the A component, which is a polyether based unit, may be selected from a polyether or a polyether derived copolymer. The polyether based unit A may be, for example, selected from a polyether, a polyether derived polyurethane, a polyether derived polyester, and the like.

In one embodiment, the A unit is selected from:

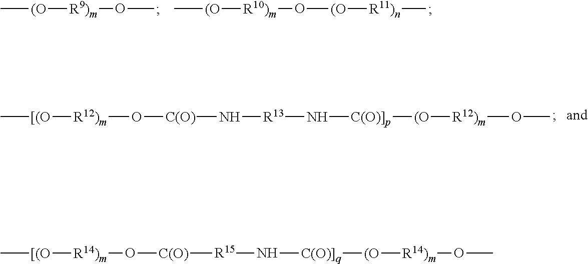

where R⁹, R¹⁰, R¹¹, R¹², R¹³ R¹⁴ and R¹⁵ are independently a C1-C20 alkylene group; m is 2 or more; n is 2 or more; p is 1 or more; and q is 1 or more.

In one embodiment the A component is a polyether group selected from methyleneoxy (—OCH₂—), ethyleneoxy (—OCH₂CH₂—), propyleneoxy (—OCH(CH₃)CH₂—), trimethyleneoxy (—OCH₂CH₂CH₂—), butyleneoxy (e.g., —OCH₂CH₂CH₂CH₂—, —OCH(CH₃)CH₂CH₂— or —OCH(CH₃)CH(CH₃)—), and pentamethyleneoxy (—OCH₂CH₂CH₂CH₂CH₂—) units.

In one embodiment the A component is a polyether copolymer, wherein the polyether group is selected from methyleneoxy (—OCH₂—), ethyleneoxy (—OCH₂CH₂—), propyleneoxy (—OCH(CH₃)CH₂—), trimethyleneoxy (—OCH₂CH₂CH₂—), butyleneoxy (e.g., —OCH₂CH₂CH₂CH₂—, —OCH(CH₃)CH₂CH₂— or —OCH(CH₃)CH(CH₃)—), pentamethyleneoxy (—OCH₂CH₂CH₂CH₂CH₂—) units or a combination thereof.

In one embodiment, the linker groups X¹ and X² are independently selected from:

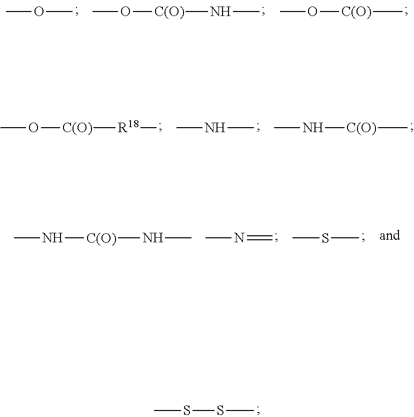

where R¹⁸ is selected from a C1-C20 divalent hydrocarbon.

R⁷ and R⁸ are independently selected from hydrogen and a hydrophobic group, provided that at least one of R⁷ and/or R⁸ is a hydrophobic group. In one embodiment, both R⁷ and R⁸ are hydrophobic groups. The hydrophobic groups R⁷ and R⁸ can be either the same or different in the same molecule and can be selected from hydrocarbyl, alkyl, aryl, arylalkyl, cycloaliphatic, perfluoroalkyl, carbosilyl, polycyclic groups, and the like. In one embodiment, the hydrophobic group is selected from a C1-C40 alkyl, a C2-C35 alkyl, a C5-C30 alkyl, or a C8-C25 alkyl. These hydrophobic groups can be either saturated or unsaturated, branched or linear. Specific examples of the hydrophobic groups include, but are not limited to, octyl, dodecyl, hexadecyl, and octodecyl groups.

Examples of suitable hydrophobically modified polyethers include, but are not limited to, those sold under the tradenames AQUAFLOW® from Ashland Specialty Chemical, BORCHI® available from Borchers Americas Inc., and ACRYSOL® available from Rohm & Haas.

The emulsion promoting agent is present in an amount of from about 0.1 wt. % to about 20 wt. %, from about 0.1 wt. % to about 10 wt. %, or from about 0.1 wt. % to about 5 wt. %, or from about 0.1 wt. % to about 3 wt. % based on the total weight of the composition.

The composition includes a surfactant. In one embodiment, the surfactant is a nonionic surfactant. The nonionic surfactant is not particularly limited. Suitable nonionic surfactants include, but are not limited to, polyoxyethylene alkyl ethers, polyoxyethylene propylene alkyl ethers, polyoxyethylene alkyl phenyl ethers, fatty alcohols, and polyoxyethylene fatty acid esters. Polyoxyethylene alkyl ethers, polyoxyethylene propylene alkyl ethers, and polyoxyethylene alkyl phenyl ethers are particularly suitable. Some examples of nonionic surfactants include, but are not limited to, polyoxyethylene octyl ether, polyoxyethylene nonyl ether, polyoxyethylene decyl ether, polyoxyethylene propylene decyl ether, polyoxyethylene lauryl ether, polyoxyethylene propylene lauryl ether, polyoxyethylene tridecyl ether, polyoxyethylene propylene tridecyl ether, polyoxyethylene myristyl ether, polyoxyethylene cetyl ether, polyoxyethylene stearyl ether, polyoxyethylene octyl phenyl ether, polyoxyethylene nonyl phenyl ether, and polyoxyethylene styrenated phenyl ether. It will be appreciated that the nonionic surfactant can comprise two or more different nonionic surfactants.

In one embodiment, the surfactant comprises one or more of sorbitan esters; polyethoxylated sorbitan esters; oleochemical derivative (e.g, Finafog PET (tradename), from Fine Organics); PEG monolaurate; polyethylene glycol octadecyl ether (e.g., BRIJ® O20, from Sigma Aldrich); polyoxyethylene stearyl ether; polyoxyethylene nonylphenyl ether, branched (e.g, Igepal® CO 720, from Sigma Aldrich); poly(oxyethylene) tridecyl ether; PEG-20 sorbitan monolaurate (e.g, Tween® 20, from Sigma Aldrich); PEG-20 sorbitan monolearate (e.g, Tween® 80, from Sigma Aldrich); sorbitan monostearate (e.g., Span® 60, from Sigma Aldrich), methacrylate Tween® 20 (from Sigma Aldrich), Grand 6047 (from Grand organics), Ecosure EH-9 (from Dow Chemicals), Mecostat® 3/752 (from Mecastat), Mecostat® 3/749 (from Mecostat); ethoxylated fatty alcohol (e.g, PRODUCT-33-CH, from Esteem Industries; Synative® AC EP 5 LV, from BASF) or a combination of two or more thereof. In one embodiment, the surfactant is a suitable sorbitan ester. Suitable sorbitan esters include, but are not limited to Tweens (e.g., Tween® 20, Tween® 60, Tween® 80, methacrylate Tween® 20, etc., all are from Sigma Aldrich) and Spans (e.g., Span® 60).

In one embodiment, the nonionic surfactant is selected from ethoxylated polyoxypropylene glycols represented by the following chemical structure: HO—(CH₂CH₂O)ₓ—(CH(CH₃)CH₂O)_{y}(CH₂CH₂O)ₓ—H, wherein x+x′ is an integer of from about 52 to about 200, more particularly from about 125 to about 200, and y is an integer of from about 39 to about 68, more particularly from about 39 to about 55. Other suitable surfactants include, but are not limited to, propoxylated polyethylene glycols, ethoxylated fatty acids, ethoxylated castor oil, alkyl polyglycosides, and polyoxyethylene sorbitan monooleates.

In various embodiments, the nonionic surfactant has a relatively high hydrophilic lipophilic balance (HLB). In embodiments, the nonionic surfactant has a HLB value of about 12, 12.5, 13, 13.5, 14, 14.2, 14.5, 15, 15.5, or 16, and/or is less than about 30, 25, 20, 19.5, 19, 18.5, 18.1, 18, 17.5, or 17. In one embodiment, the HLB of the nonionic surfactant ranges from about 12 to about 22, from about 14 to about 20, or from about 14 to about 18.

The composition may optionally include other surfactants. In one embodiment, the composition optionally includes an ionic surfactant. The ionic surfactant can be selected from an anionic surfactant or a salt thereof. Examples of suitable anionic surfactants include, but are not limited to, carboxylic acid surfactants, sulfuric acid surfactants, sulfonic acid surfactants, phosphoric acid surfactants, salts of such surfactants, or a combination of two or more surfactants thereof.

Representative and non-limiting examples of carboxylic acid surfactants include, for example, a carboxylic acid, such as poly acrylic acid, poly methacrylic acid, poly maleic acid, poly maleic anhydride, a copolymer of maleic acid or maleic anhydride and an olefin, as, for example, ethylene, propylene, isobutylene, diisobutylene, and the like, a copolymer of acrylic acid and itaconic acid, a copolymer of methacrylic acid and itaconic acid, a copolymer of maleic acid or maleic anhydride and styrene, a copolymer of acrylic acid and methacrylic acid, a copolymer of acrylic acid and methyl acrylate ester, a copolymer of acrylic acid and vinyl acetate, a copolymer of acrylic acid and maleic acid or maleic anhydride, a polyoxyethylene alkyl ether acetic acid where the alkyl group has from 4 to 28 carbon atoms, more preferably from 8 to 18 carbon atoms, an N-methyl-fatty acid sarcosinate where the fatty acid has from 4 to 28 carbon atoms, more preferably from 8 to 18 carbon atoms, a resin acid, and a fatty acid having 4 to 28 carbon atoms, more preferably from 8 to 18 carbon atoms, and salts of these carboxylic acids.

Representative and non-limiting examples of sulfuric acid ester surfactants include for example, a sulfuric acid ester, such as an alkyl sulfuric acid ester where the alkyl group has from 4 to 28 carbon atoms, more preferably from 8 to 18 carbon atoms, a polyoxyethylene alkyl ether sulfuric ester where the alkyl group bas from 4 to 28 carbon atoms, more preferably from 8 to 18 carbon atoms, a polyoxyethylene mono or di alkyl phenyl ether sulfuric acid ester where the alkyl group has from 4 to 28 carbon atoms, more preferably from 8 to 18 carbon atoms, a sulfuric acid ester of a polymer of a polyoxyethylene mono or di alkyl phenyl ether where the alkyl group has from 4 to 28 carbon atoms, more preferably from 8 to 18 carbon atoms, a polyoxyethylene mono, di, or tri phenyl ether sulfuric acid ester, a polyoxyethylene mono, di, or tri benzyl phenyl ether sulfuric acid ester, a polyoxyethylene mono, di, or tri styryl phenyl ether sulfuric acid ester, a sulfuric acid ester of a polymer of a polyoxyethylene mono, di, or tri styryl phenyl ether, a sulfuric acid ester of a polyoxyethylene polyoxypropylene block polymer, a sulfated oil, a sulfated fatty acid ester, a sulfated fatty acid, and a sulfated olefin and salts of these sulfuric acid esters.

Representative and non-limiting examples of sulfonic acid surfactants include, for example, a sulfonic acid, such as a paraffin sulfonic acid where the paraffin has from 8 to 22 carbon atoms, an alkyl benzene sulfonic acid where the alkyl group has from 4 to 28 carbon atoms, more preferably from 8 to 12 carbon atoms, a formalin condensate of an alkyl benzene sulfonic acid where the alkyl group has from 4 to 28 carbon atoms, more preferably from 8 to 12 carbon atoms, a formalin condensate of a cresol sulfonic acid, an α-olefin sulfonic acid where the alpha-olefin has from 8 to 16 carbon atoms, a dialkyl sulfo succinic acid where the alkyl group has from 4 to 28 carbon atoms, more preferably from 8 to 12 carbon atoms, a lignin sulfonic acid, a polyoxyethylene mono or di alkyl phenyl ether sulfonic acid where the alkyl group has from 4 to 28 carbon atoms, more preferably from 8 to 12 carbon atoms, a polyoxyethylene alkyl ether sulfo succinic acid half ester where the alkyl group has from 4 to 28 carbon atoms, more preferably from 8 to 18 carbon atoms, a naphthalene sulfonic acid, a mono or di alkyl naphthalene sulfonic acid where the alkyl group has from 1 to 12 carbon atoms, more preferably from 1 to 6 carbon atoms, a formalin condensate of a naphthalene sulfonic acid, a formalin condensate of a mono or di alkyl naphthalene sulfonic acid where the alkyl group has from 1 to 12 carbon atoms, more preferably from 1 to 6 carbon atoms, a formalin condensate of a creosote oil sulfonic acid, an alkyl diphenyl ether disulfonic acid where the alkyl group has from 4 to 28 carbon atoms, more preferably from 8 to 12 carbon atoms, Igepon T (product name for sodium N-oleoyl-N-methyltaurate), a polystyrene sulfonic acid, and a copolymer of a styrene sulfonic acid and methacrylic acid, and salts of these sulfonic acids.

Representative and non-limiting examples of phosphoric acid ester surfactants include a phosphoric acid ester, such as an alkyl phosphoric acid ester where the alkyl group has from 4 to 28 carbon atoms, more preferably from 8 to 12 carbon atoms, a polyoxyethylene alkyl ether phosphoric acid ester where the alkyl group has from 4 to 28 carbon atoms, more preferably from 8 to 18 carbon atoms, a polyoxyethylene mono or di alkyl phenyl ether phosphoric acid ester where the alkyl group has from 4 to 28 carbon atoms, more preferably from 8 to 12 carbon atoms, a phosphoric acid ester of a polymer of a polyoxyethylene mono, di, or tri alkyl phenyl ether where the alkyl group has from 4 to 28 carbon atoms, more preferably from 8 to 12 carbon atoms, a polyoxyethylene mono, di, or triphenyl ether phosphoric acid ester, a polyoxyethylene mono, di, or tri benzyl phenyl ether phosphoric acid ester, a polyoxyethylene mono, di, or tri styryl phenyl ether phosphoric acid ester, a phosphoric acid ester of a polymer of a polyoxyethylene mono, di, or tri styryl phenyl ether, a phosphoric acid ester of a polyoxyethylene polyoxypropylene block polymer, phosphatidylcholine, phosphatidyl ethanolimine, and a condensed phosphoric acid, such as, for example, tripoly phosphoric acid, and salts of these phosphoric acid esters.

Salts of the surfactants may comprise the above anionic materials and a counter ion. Suitable counter ions for salts of the anionic surfactants include, but are not limited to, alkaline metals, including lithium, sodium, potassium, and the like, alkaline earth metals, including calcium, magnesium, and the like, ammonium, and a variety of primary, secondary, tertiary and quaternary amines, including for example, an alkylamine, a cycloalkylamine, and an alkanol amine.

Particularly suitable anionic surfactants include, but are not limited to, sulfonic acids. Examples include a salt of the surface active sulfonic acids used in the emulsion polymerization to form the hydroxylated polydiorganosiloxane as shown in U.S. Pat. No. 3,294,725, which is hereby incorporated by reference in its entirety. The alkali metal salts of the sulfonic acids, where the sodium salts are particularly suitable. The sulfonic acid can be illustrated by aliphatically substituted benzenesulfonic acids, aliphatically substituted naphthalene sulfonic acids, aliphatic sulfonic acids silylalkylsulfonic acids and aliphatically substituted diphenylethersulfonic acids.

The surfactant is present in an amount of from about 0.5 wt. % to about 20 wt. %, from about 1 wt. % to about 12 wt. %, or from about 3 wt. % to about 10 wt. % based on the total weight of the composition.

In one embodiment, the surfactant and the emulsion promoting agent are provided in a weight ratio of surfactant to emulsion promoting agent of from about 1:200 to about 200:1, from about 1:50 to about 50:1, from about 1:10 to about 10:1, from about 1:10 to about 1:1.

The composition also includes water. The water can be provided at a high purity level and can be demineralized. The water is present in an amount of from about 10 wt. % to about 75 wt. %, from about 15 wt. % to about 60 wt. %, or from about 20 wt. % to about 50 wt. % based on the total weight of the composition.

The composition may include a solvent. In one embodiment, the solvent is selected from a hydrocarbon based solvent. Examples of suitable solvents include, but are not limited to aliphatic or aromatic hydrocarbons. In one embodiment, the solvent is selected from toluene, xylene, hexane, heptane, isooctane, and the like. The solvent can be present in an amount of from about 0 wt. % to about 15 wt. %, from about 0.1 wt. % to about 12 wt. %, or from about 1 wt. % to about 8 wt. % based on the total weight of the composition. In one embodiment, the solvent is added as part of the silicone resin component.

The composition may include other additives or resins as may be desired for a particular use or intended application. Such other additives or resins may include, but are not limited to, pigments, silanes, wetting agents, dispersants, rheology modifiers, foam arresters, coalescing agents, organic resins, silicone compounds and the like. Additives can be pre-emulsified or dispersed in water for better compatibility with the composition. The additives can be present in an amount of from about 0 wt. % to about 60 wt. %, from about 0.01 wt. % to about 50 wt. %, or from about 0.1 wt. % to about 20 wt. %, or from about 0.1 wt. % to about 5 wt. % based on the total weight of the composition.

In embodiments, the compositions may include an organic or hybrid organic-silicone or hybrid silylate-organic-resin resin. The organic component of the resin is not particularly limited and can be chosen as desired for a particular purpose or intended application, such as polymers based on acrylic, epoxy, alkyd, urethane, urea, ester, etc. In one embodiment, the organic resin is a waterborne organic resin. In another embodiment, the waterborne organic resin comprises a latex polymer formed by emulsion polymerization of at least one ethylenically unsaturated monomer in water using surfactants and water soluble initiators. Typical ethylenically unsaturated monomers include vinyl monomers, acrylic monomers, acrylate monomers, methacrylic monomers, methacrylate monomers, acid-functional monomers, allylic monomers and acrylamide monomers. For architectural applications, the waterborne organic resin(s) may be formed from vinyl monomers and/or acrylic monomers. Suitable vinyl monomers include vinyl esters, vinyl aromatic hydrocarbons, vinyl aliphatic hydrocarbons, vinyl alkyl ethers, or a mixture of two or more thereof. Examples of vinyl esters that may be used include, but are not limited to, vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates, or a combination or two or more thereof. Examples of vinyl aromatic hydrocarbons that may be used include, but are not limited to, styrene, methyl styrenes and other lower alkyl styrenes, chlorostyrene, vinyl toluene, vinyl naphthalene, divinyl benzene, or a combination of two or more thereof. Examples of vinyl aliphatic hydrocarbons that may be used include, but are not limited to, vinyl chloride and vinylidene chloride as well as alpha olefins such as ethylene, propylene, isobutylene, hexylene and octylene, as well as conjugated dienes such as, but not limited to, 1,3 butadiene, methyl-2-butadiene, 1,3-piperylene, 2,3-dimethyl butadiene, isoprene, cyclohexadiene, cyclopentadiene and dicyclopentadiene. Examples of vinyl alkyl ethers that may be used include, but are not limited to, methyl vinyl ether, isopropyl vinyl ether, n-butyl vinyl ether and isobutyl vinyl ether Acrylic monomers suitable for use in the present invention include any compounds having acrylic functionality such as, but not limited to, alkyl acrylates, acrylic acids, as well as aromatic derivatives of acrylic acid, acrylamides and acrylonitrile. Methacrylic monomers suitable for use in the present invention include any compounds having methacrylic functionality such as, but not limited to, alkyl methacrylates, methacrylic acids, as well as aromatic derivatives of methacrylic acid and methacrylamides. Typically, the alkyl acrylate monomers (also referred to herein as “alkyl esters of acrylic acid”) and methacrylate monomers (also referred to herein as “alkyl esters of methacrylic acid”) will have an alkyl group containing from 1 to 12, preferably about 1 to 5, carbon atoms per molecule.

In one embodiment, the organic or hybrid organic-silicone and/or hybrid silylate-organic-resin resin may be present in an amount of from about 0 wt. % to about 95 wt. %, from about 0.1 wt. % to about 50 wt. %, or from about 0.1 wt. % to about 30 wt. % or from about 0.5 wt. % to about 10 wt. % based on the total weight of the composition.

Suitable acrylic monomers include, but are not limited to, methyl acrylate, ethyl acrylate, butyl acrylate, propyl acrylate, 2-ethyl hexyl acrylate, decyl acrylate, isodecyl acrylate and neopentyl acrylate. Aryl acrylate monomers include phenyl acrylate and tolyl acrylate. Aralkyl acrylate monomers include benzyl acrylate and phenethyl acrylate. Cycloalkyl acrylate monomers include cyclohexyl acrylate, isobornyl acrylate, 1-adamatyl acrylate. Various reaction products such as butyl, phenyl, and cresyl glycidyl ethers reacted with acrylic acid, hydroxyl alkyl acrylates, such as hydroxyethyl and hydroxypropyl acrylates, amino acrylates, as well as acrylic acids such as acrylic acid, ethacrylic acid, alpha-chloroacrylic acid, alpha-cycanoacrylic acid, crotonic acid, beta-acryloxy propionic acid, and beta-styryl acrylic acid can be used as monomers suitable methacrylic monomers include, but are not limited to, methyl methacrylate, ethyl methacrylate, butyl methacrylate, propyl methacrylate, 2-ethyl hexyl methacrylate, decyl methacrylate, isodecyl methacrylate and neopentyl methacrylate. Aryl methacrylate monomers include phenyl methacrylate and tolyl methacrylate. Aralkyl methacrylate monomers include benzyl methacrylate and phenethyl methacrylate. Cycloalkyl methacrylate monomers include cyclohexyl methacrylate, isobornyl methacrylate, 1-adamatyl methacrylate. Various reaction products such as butyl, phenyl, and cresyl glycidyl ethers reacted with methacrylic acid, hydroxyl alkyl methacrylates, such as hydroxyethyl and hydroxypropyl methacrylates, amino methacrylates, as well as methacrylic acids such as methacrylic acid, and beta-styryl methacrylic acid can be used as monomers.

In one embodiment, the organic or hybrid organic-silicone and/or hybrid silylate-organic-resin resin may contain acrylic monomers in an amount of from about 0 wt. % to about 100 wt. %, from about 0.1 wt. % to about 100 wt. %, or from about 0.1 wt. % to about 50 wt. % or from about 0.5 wt. % to about 30 wt. %, 0.5 wt. % to about 30 wt. % based on the total weight of the composition

Pigments may be used to contribute color or opacity, protect the substrate from UV light, increase hardness, decrease ductility, and/or adjust gloss level. The pigments may be synthetic or natural. Inorganic or organic pigments can be employed. Examples of pigments may include clays, calcium carbonate, mica, metal powder, silicas, talcs, calcined clays, blanc fixe, precipitated calcium carbonate, synthetic pyrogenic silicas, the like, or a combination thereof.

Examples of inorganic pigments may include, but are not limited to, aluminum pigments such as silicates of sodium and aluminum containing sulfur (ultramarine violet) and a complex naturally occurring pigment of sulfur-containing sodio-silicate (Na₈₋₁₀Al₆Si₆O₂₄S₂₋₄) (ultramarine); barium copper pigments such as Chinese purple (BaCuSi₂O₆) and dark blue (BaCu₂Si₂O₇), copper pigments such as a synthetic pigment of calcium copper silicate (CaCuSi₄O₁₀), cupric acetoarsenite (Cu(C₂H₃O₂)₂·3Cu(AsO₂)₂); barium pigments such as barium sulfate (BaSO₄); manganese pigments such as manganic ammonium pyrophosphate (NH₄MnP₂O₇); cobalt pigments such as cobalt stannate (CoO₃Sn), potassium cobaltinitrite (Na₃Co(NO₂)₆), cobalt chromite (CoCr₂O₄), cobalt titanate (Co₂TiO₄); iron pigments such as a synthetic pigment of ferric hexacyanoferrate (Fe₇(CN)₁₈), a naturally occurring clay of monohydrated ferric oxide (Fe₂O₃·H₂O), anhydrous Fe₂O₃; cadmium pigments such as cadmium sulfide (CdS), cadmium sulfoselenide (Cd₂SSe), cadmium selenide (CdSe); chromium pigments such as chromic oxide (Cr₂O₃), a pigment of hydrated chromic oxide (Cr₂O₃·H₂O), natural pigment of plumbous chromate (PbCrO₄), a naturally occurring pigment mixture composed of lead (II) chromate and lead(II) oxide (PbCrO₄+PbO); arsenic pigments such as monoclinic arsenic sulfide (As₂S₃); lead pigments such as lead antimonite (Pb(SbO₃)₂, basic plumbous carbonate ((PbCO₃)₂·Pb(OH)₂); mercury pigments such as mercuric sulfide (HgS); carbon pigments such as carbon black; antimony pigments such as stibous oxide (Sb₂O₃); zinc pigments such as zinc oxide (ZnO) or zinc chromate (ZnCrO₄); titanium pigments such as nickel antimony titanium yellow rutile (NiO·Sb₂O₃·20TiO₂) or titanium dioxide (TiO₂); a complex sulfur-containing sodio-silicate (Na₅₋₁₀Al₆Si₆O₂₄S₂₋₄) containing lazurite known as ultramarine blue, or the like.

Examples of organic pigments may include, but are not limited to, diarylide aniline yellow pigment; benzimidazole yellow dyes; heterocyclic yellow dyes; disazo condensation yellow dyes such as arylide yellow, isoindoline yellow, methane yellow, tetrachloroisoindolinone yellow, azomethine yellow, quinophthalone yellow, or triazinyl yellow, naphthol orange, calrion red, benzimidazolone orange; phthalocyannine green dyes with chemical formula ranging from C₃₂H₃Cl₁₃CuN₈ to C₃₂HCl₁₅CuN₈, copper phthalocyannine; 8,18-dichloro-5,15-diethyl-5,15-dihydrodiindolo(3,2-b:3′,2′-m)tri-phenodioxazine known as diooxazine violet, or the like.

In one embodiment, the pigments may be present in an amount of from about 0 wt. % to about 20 wt. %, from about 0.1 wt. % to about 10 wt. %, or from about 0.5 wt. % to about 5 wt. % based on the total weight of the composition.

Fillers may be used for thickening of the film, reinforcing the binder, giving the paint texture, and/or increasing the paint volume. The fillers may include diatomaceous earth, talc, lime, barytes such as barium sulfate, clay, kaolin clay, precipitated or ground calcium carbonate, chalk, limestone, marble, magnesium carbonate, dolomite, fine quartz, silicates, metal powder, the like, or a combination thereof.

In one embodiment, fillers may be present in an amount of from about 0 wt. % to about 90 wt. %, from about 0.1 wt. % to about 60 wt. %, or from about 0.1 wt. % to about 30 wt. % or from about 0.5 wt. % to about 10 wt. % based on the total weight of the composition.

Additives may serve a variety of functions such as to modify surface tension, flow and leveling properties, appearance, gloss, texturing, increase wet edge and/or antifreeze properties, improve pigment stability, control foaming and/or skinning, modify rheology, modify mar resistance, act as catalysts, driers, thickeners, stabilizers, emulsifiers, texturizers, adhesion promoters, UV stabilizers, corrosion inhibitors, texturizers, de-glossing agents, biocides, fungicides, insecticides, algaecides, the like, or a combination thereof.

Examples of additives may be silicone polyether copolymers, a dispersion of high molecular weight polysiloxane or polydimethylsiloxane and silicone surfactant as additives increasing mar resistance and providing or improving slip; ethylene oxide surfactants; silicone emulsions, fluorosilicone, organo-modified silicone copolymers as additives providing foam control; aminopropyltriethoxysilane, 3-methacryloxypropyltrimethoxysilane, cationic vinylbenzyl and amino-functionalmethoxy-silane, glycidoxypropyltrimethoxysilane, silanol-functional additives, aqueous solutions of amino-functional silicone polymers as adhesion promoters and pigment treatment additives; silane/siloxane blends as additives promoting water resistance; arylalkyl-modified silicone, silicone polyether copolymers as additives improving leveling and gloss; silicone elastomer particles with epoxy functionality improving abrasion resistance and adding a smooth, matter finish; silicone polyether copolymers as additives enhancing substrate wetting; 2,2′-(2,5-thiophenediyl)bis(5-tert-butylbenzoxazole) as an optical brightener; 2-[2-hydroxy-3,5-di-(1,1-dimethylbenzyl)]-2H-benzotriazole, 2-(2H-benzotriazole-2-yl)-4-methylphenyl as UV light absorbers; tris(2,4-di-tert-butylphenyl)phosphite, stearyl-3-(3′,5′-di-tert-butyl-4-hydroxyphenyl) propionate, 2,2′-methylenebis (4-methyl-6-tert-butylphenol) as stabilizers; tetrachloroizo phthalonitrile, 3-iodo-2-propynyl butyl carbamate, 2-n-octyl-4-isothiazolin-3-one, diiodomethyl-p-tolysulphone, N-(trimethylthio) phtalamine, 1,2-benzisothiazolin-3-one as biocides; 2-(4-thiazolyl(benzimidazole), dichloroctylisothiazolone as fungicide/algaecide; potassium sodium phosphate as a buffer; hydrophobic copolymer polyelectrolyte as a pigment dispersant; modified hydroxyethyl methyl cellulose, as a thickener; modified polyols as foam suppressors; ester alcohol as a coalescent; calcium carbonate as an extender; talc as an additive to provide pigment spacing, firmness, anti-cracking, and barrier properties; aqueous butyl acrylate-styrene copolymer for dispersion; and (N-(2-aminoethyl)-3-aminopropyltrimethoxysilane, and aqueous acetic acid as catalysts. Any other additive for interior and exterior paint is also contemplated.

In one embodiment, the composition consists essentially of the silicone resin, the surfactant, water, and the emulsion promoting agent. In one embodiment, the composition is substantially free from a solvent other than water. That is, the composition may contain non-aqueous solvents in an amount not greater than 15% by weight of the total composition, preferably not greater than 5% by weight, more preferably not greater than 1% by weight. In another embodiment, the composition may be completely free of non-aqueous solvents. Such non-aqueous solvents may include, but are not limited to, organic based solvents.

The silicone emulsion can be prepared by mixing the surfactant, the emulsion promoting agent, and the silicone resin to provide an oil in water emulsion. Other optional additives (e.g, dispersant, wetting agent, pigment, etc.) can be added along with or to those components at any time during the formation of the emulsion.

In one embodiment, the silicone emulsion is prepared by (i) contacting a nonionic surfactant with an emulsion promoting agent to provide a first mixture; (ii) homogenizing the first mixture to form a homogenized mixture; and (iii) adding silicone resin to the homogenized mixture to form an oil in water emulsion. The respective components can be dissolved in water as needed. Heat may be applied as necessary to effectively dissolve a component. In one embodiment, formation of the emulsion can be carried out at temperatures of from about 20° C. to about 80° C., from about 25° C. to about 75° C., from about 30° C. to about 60° C., or from about 40° C. to about 50° C. The viscosity of any resulting emulsion can be controlled by varying the amount of water included in the blend. This can best be accomplished by first forming a premix comprised of the cellulose ethers and silicone resins along with part of the water. This premix can be emulsified by combining it with the anionic emulsifier and the remaining water. The accompanying examples demonstrate that the water may also be added in three increments.

The silicone emulsion can be added to a paint or coating composition. The paints and coatings for purposes of the current invention mean any liquid, liquefiable, or mastic composition, which converts to a solid film after application to a substrate. The paints and coatings may be solvent-based or water based. Examples of paints and coatings systems include, but are not limited to, alkyd based; emulsion/latex paints or acrylic paints; polyurethane emulsions; polyurethane dispersions; polyester emulsions; epoxy emulsions; polyester emulsions; high-solids paints with low volatile organic compound content; powder coatings; or radiation curable coatings.

The paint or coating may be applied to any surface as desired for a particular purpose or intended application. The paints and coatings may be any paint or coating suitable for interior and/or exterior use, such as coatings over masonry, plasters, cellulose, and the like. The paint or coating can be applied to surface such as, but not limited to, metal such as aluminum, wood, cement, brick, with or without prior coating with an adhesion primer. The paint or coating can be applied to the surfaces by any suitable means such as by brushing, spraying, etc.

The following examples illustrate embodiments of materials in accordance with the disclosed technology. The examples are intended to illustrate aspects and embodiments of the disclosed technology, and are not intended to limit the claims or disclosure to such specific embodiments.

### EXAMPLES

Table 1 includes a brief summary of ingredients used in examples along with sources.

TABLE 1
Raw materials used.

| Ingredients used | Terminology | Description | Source |
|---|---|---|---|
| Silanol | SR1 | 60% solid, methyl/phenyl and T/D | Momentive |
| terminated | | resin in xylene | Performance |
| silicone | | | Materials |
| resin in | SR2 | 80% solid, methyl/phenyl and T/D | Momentive |
| solvent | | resin in toluene | Performance |
| | | | Materials |
| | SR3 | 50% solid methyl resin with 100% T | Momentive |
| | | in toluene | Performance |
| | | | Materials |
| Surfactant | Product 33 CH | Non-ionic surfactant | Esteem Industries |
| | | | Private Ltd |
| | Grand 6047 | Non-ionic surfactant | Esteem Industries |
| | | | Private Ltd |
| Emulsion | Aquaflow NLS-220 | Hydrophobically modified | Ashland |
| promoting | | polyether | |
| agent | Rheovis ® PE 1331 | Hydrophobic modified polyether | BASF |
| | Rheovis ® PU 1291 | Hydrophobic modified ethoxylated | BASF |
| | | urethane | |

### Comparative Example 1

8.88 g of Product 33 CH (nonionic surfactant; HLB approximately 18) was taken and dissolved in 33.21 g of demineralized water at 80° C. 5.92 g of Grand 6047 (nonionic surfactant; HLB approximately 13) was mixed using a Dispermat® disperser (available from VMA-Getzmann) at 500 rpm with Product 33 CH solution at 35° C. 91.95 g of a silanol terminated silicone resin (SR-1) with Methyl to Phenyl molar ratio of 1.27 and T to D molar ratio of 2.75 was pre-stripped to about 13% xylene and was charged to the vessel at room temperature and allowed to disperse for 20 minutes. At the end, 42.84 g of demineralized water was added in three lots at an interval of 10 minutes at 1000 rpm.

### Comparative Example 2

12.00 g of Product 33 CH was taken and dissolved in 44.85 g of demineralized water at 80° ° C. 8.00 g of Grand 6047 was mixed using Dispermat disperser at 500 rpm with Product 33 CH solution at 35° C. 91.95 g of silicone resin SR-1 was pre-stripped to about 13% xylene and was charged to the vessel at room temperature and allowed to disperse for 20 minutes. At the end, 43.2 g of demineralized water was added in three lots at an interval of 10 minutes at 1000 rpm.

### Example 1

8.88 g of Product 33 CH was taken and dissolved in 33.25 g of demineralized water at 80° C. 5.92 g of Grand 6047 was mixed using Dispermat disperser at 500 rpm with Product 33 CH solution at 35° C. Aquaflow NLS-220 added in an amount 17.2 g and thoroughly mixed with the solution of Product 33 CH and Grand 6047. After, 91.95 g of silicone resin SR-1 was pre-stripped to about 13% xylene and charged to the vessel at room temperature and allowed to disperse for 20 minutes. A water reducible thick paste was formed immediately. At the end, 42.8 g of demineralized water was added in three lots at an interval of 10 minutes at 1000 rpm. Subsequently, the water reducible emulsion was characterized and found to have a solid content of 51.02% (measured after heating in oven at 150° C. for 30 min.) and particle size near 0.590 micron for 50% of particle's distribution of the emulsion (using a Malvern Mastersizer 2000).

### Example 2

7.92 g of Product 33 CH was taken and dissolved in 29.88 g of demineralized water at 80° C. 5.4 g of Grand 6047 was mixed using Dispermat disperser at 500 rpm with Product 33 CH solution at 35° C. Rheovis® PE 1331 was added in an amount 15.48 g and thoroughly mixed with the solution of Product 33 CH and Grand 6047. After, 79.74 g of silicone resin SR-1 was pre-stripped to about 8.4% xylene and charged to the vessel at room temperature and allowed to disperse for 15 minutes. A water reducible thick paste was formed immediately. At the end, 41.58 g of demineralized water was added in three lots at an interval of 10 minutes at 1000 rpm. Subsequently, the water reducible emulsion was characterized and found to have a solid content of 51.00% (measured after heating in oven at 150° C. for 30 min.) and particle size near 1.2 micron for 50% of particle's distribution of the emulsion (using a Malvern Mastersizer 2000).

### Example 3

4.4 g of Product 33 CH was taken and dissolved in 16.6 g of demineralized water at 80° C. 3 g of Grand 6047 was mixed using Dispermat disperser at 500 rpm with Product 33 CH solution at 35° C. Rheovis® PU 1291 was added in an amount 8.6 g and thoroughly mixed with the solution of Product 33 CH and Grand 6047. After, 44.3 g of silicone resin SR-1 was pre-stripped to about 8.4% xylene and charged to the vessel at room temperature and allowed to disperse for 15 minutes. A water reducible thick paste was formed immediately. At the end, 23.1 g of demineralized water was added in three lots at an interval of 10 minutes at 1000 rpm. Subsequently, the water reducible emulsion was characterized and found to have a solid content of 47.30% (measured after heating in oven at 150° C. for 30 min.) and particle size near 1.4 micron for 50% of particle's distribution of the emulsion (using a Malvern Mastersizer 2000).

### Example 4

7.99 g of Product 33 CH was taken and dissolved in 29.88 g of demineralized water at 80° C. 5.33 g of Grand 6047 was mixed using Dispermat disperser at 500 rpm with Product 33 CH solution at 35° C. Rheovis® PE 1331 was added in an amount 15.48 g and thoroughly mixed with the solution of Product 33 CH and Grand 6047. After, 91.35 g of a silanol terminated silicone resin (SR-2) having 80% solid with Methyl to Phenyl molar ratio of 0.66 and T to D molar ratio of 1.5 in toluene was charged to the vessel at room temperature and allowed to disperse for 15 minutes. A water reducible thick paste was formed immediately. At the end, 26.9 g of demineralized water was added in three lots at an interval of 10 minutes at 1000 rpm. Subsequently, the water reducible emulsion was characterized and found to have a solid content of 47.04% (measured after heating in oven at 150° C. for 30 min.) and particle size near 0.652 micron for 50% of particle's distribution of the emulsion (using a Malvern Mastersizer 2000).

### Example 5

8.4 g of Product 33 CH was taken and dissolved in 36.32 g of demineralized water at 80° C. 5.6 g of Grand 6047 was mixed using Dispermat disperser at 500 rpm with Product 33 CH solution at 35° C. Aquaflow NLS-220 was added in an amount 17.2 g and thoroughly mixed with the solution of Product 33 CH and Grand 6047. After, 99.04 g of a silanol terminated silicone resin (SR-3) with 100% Methyl group and 100% T was pre-stripped to about 17% toluene and charged to the vessel at room temperature and allowed to disperse for 15 minutes. A water reducible thick paste was formed immediately. At the end, 33.44 g of demineralized water was added in three lots at an interval of 10 minutes at 1000 rpm. Subsequently, the water reducible emulsion was characterized and found to have a solid content of 55.17% (measured after heating in oven at 150° ° C. for 30 min.) and particle size near 0.278 micron for 50% of particle's distribution of the emulsion (using a Malvern Mastersizer 2000).

### Example 6

5% of Product 33 CH was taken and dissolved in 15.7% of demineralized water at 80° C. 3.4% of Grand 6047 was mixed using Dispermat disperser at 500 rpm with Product 33 CH solution at 35° C. Aquaflow NLS-220 was added in an amount 4% and thoroughly mixed with the solution of Product 33 CH and Grand 6047. After, 42.3% of a silanol terminated silicone resin (SR-1) was pre-stripped to about ˜4% xylene and charged to the vessel at 55° C. temperature and allowed to disperse for 15 minutes. A water reducible thick paste was formed immediately. At the end, 29.6% of demineralized water was added in three lots at an interval of 10 minutes at 1000 rpm and cooled to room temperature. Subsequently, the water reducible emulsion was characterized and found to have a solid content of 50.3% (measured after heating in oven at 150 ºC for 30 min.) and particle size near 0.670 micron for 50% of particle's distribution of the emulsion (using a Malvern Mastersizer 2000).

A summary of the compositions is provided in Table 2. As shown in Table 2, Comparative Examples did not form a water reducible stable emulsion. Upon emulsification using only surfactant, emulsion was incomplete. The composition comprising the emulsion promoting agent formed a stable emulsion and was water reducible upon emulsification.

TABLE 2
Summary of results

| | Amount of | Amount of | Amount of | Amount of | | |
|---|---|---|---|---|---|---|
| | Nonionic | Polyorgano- | Demineralized | Emulsion | | |
| | Surfactant | siloxane* | Water | Promoting | | |
| Examples | (wt %) | (wt %) | (wt %) | Agent (wt %) | Stability | Emulsification |
| Comparative | 7.4 | 46.0 | 46.6 | 0 | Not stable | No to |
| Example 1 | | (SR1) | | | O/W^{#} | Incomplete |
| | | | | | emulsion | O/W |
| | | | | | | Emulsion |
| Comparative | 10 | 46.0 | 44.0 | 0 | Not stable | No to |
| Example 2 | | (SR 1) | | | O/W | Incomplete |
| | | | | | emulsion | O/W |
| | | | | | | Emulsion |
| Example 1 | 7.4 | 46.0 | 38.0 | 8.6 | Stable O/W | Complete |
| | | (SR 1) | | Aquaflow | emulsion | O/W |
| | | | | NLS-220 | | Emulsification |
| Example 2 | 7.4 | 44.3 | 39.7 | 8.6 | Stable O/W | Complete |
| | | (SR1) | | Rheovis ® | emulsion | O/W |
| | | | | PE 1331 | | Emulsification |
| Example 3 | 7.4 | 44.3 | 39.7 | 8.6 | Stable O/W | Complete |
| | | (SR1) | | Rheovis ® | emulsion | O/W |
| | | | | PU 1291 | | Emulsification |
| Example 4 | 7.4 | 50.75 | 33.25 | 8.6 | Stable O/W | Complete |
| | | (SR2) | | Rheovis ® | emulsion | O/W |
| | | | | PE 1331 | | Emulsification |
| Example 5 | 7 | 49.52 | 34.88 | 8.6 | Stable O/W | Complete |
| | | (SR3) | | Aquaflow | emulsion | O/W |
| | | | | NLS-220 | | Emulsification |
| Example 6 | 8.4 | 42.3 | 45.3 | 4.0 | Stable O/W | Complete |
| | | (SR1) | | Aquaflow | emulsion | O/W |
| | | | | NLS-220 | | Emulsification |

*Solid content of resins as per examples1-6 and comparative examples 1&2.
^{#}O/W stands for oil in water.

As shown in Table 2, the composition in accordance with aspects and embodiments of the invention (Example 1) that comprises the present emulsion promoting agent (e.g., Aquaflow NLS-220 in Example 1), readily and surprisingly results in an water-borne emulsion, while the compositions of the comparative examples (Comparative Example 1 and Comparative Example 2) did not achieve complete emulsification. Further, the composition of the invention (Example 1) results in an emulsion that demonstrates high stability.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a silicone emulsion, methods of making a silicone emulsion, and coating compositions comprising such an emulsion. Modifications may occur to those skilled in the art and to those who may make and use the invention. The disclosed embodiments are merely for illustrative purposes and not intended to limit the scope of the invention or the subject matter set forth in the claims.

What is claimed is:

1. A composition comprising:
a silicone resin;
a surfactant;
water
and
an emulsion promoting agent,
wherein the emulsion promoting agent is selected from the group consisting of a hydrophobically modified polyether, a hydrophobically modified polyether derived copolymer, wherein the hydrophobically modified polyether, and hydrophobically modified polyether derived copolymer have hydrophobic groups at both the terminals.

2. The composition of claim 1 consisting essentially of the silicone resin, the surfactant, water, and the emulsion promoting agent.

3. The composition of claim 1, wherein the emulsion promoting agent is a compound represented by the general formula: 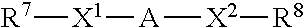
where A is a polyether; X¹ and X² are independently selected from a linker group selected from the group consisting of a polyether, a polyether derived polyurethane and a polyether derived polyester; and R⁷ and R⁸ are independently selected from a monovalent hydrophobic group.

4. The composition of claim 3, wherein A is selected from the group consisting of: 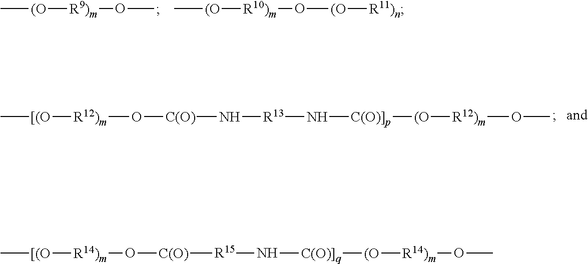
where R⁹, R¹⁰, R¹¹, R¹², R¹³ R¹⁴ and R¹⁵ are each independently a C1-C20 alkylene group; m is 2 or more; n is 2 or more; p is 1 or more; and q is 1 or more.

5. The composition of claim 3, wherein A comprises a polyether or a copolymer thereof, wherein the polyether is selected from the group consisting of (—OCH₂-)m, (—OCH₂CH₂-)m, (—OCH(CH₃)CH₂-)m, (—OCH₂CH₂CH₂-)m, (—OCH₂CH₂CH₂CH₂-)m, (—OCH(CH₃)CH₂CH₂-)m, (—OCH(CH₃)CH(CH₃)-)m, (—OCH₂CH₂CH₂CH₂CH₂-)m.

6. The composition of claim 4, wherein X¹ and X² are each independently selected from: —O—; —O—C(O)—NH—; —O—C(O)—; —O—C(O)—R¹⁸—; —NH—; —NH—C(O)—; —NH—C(O)—NH—; —N═; —S—; and —S—S—; and R¹⁸ is a C1-C20 divalent hydrocarbon.

7. The composition of claim 4, wherein R⁷ and R⁸ are each independently a hydrogen or a hydrophobic group, provided that at least one of R⁷ and R⁸ is a hydrophobic group.

8. The composition of claim 7, wherein R⁷ and R⁸ are each a hydrophobic group.

9. The composition of claim 8, wherein R⁷ and R⁸ are each independently a C1-C40 alkyl.

10. The composition of claim 9, wherein R⁷ and R⁸ are each independently a C8-C25 alkyl.

11. The composition of claim 1, wherein the surfactant is a nonionic surfactant.

12. The composition of claim 11, wherein the surfactant has a hydrophilic-lipophilic balance of from about 12 to about 30.

13. The composition of claim 11, wherein the surfactant is selected from the group consisting of a polyoxyethylene alkyl ether, a polyoxyethylene propylene alkyl ether, a polyoxyethylene alkyl phenyl ether, a fatty alcohol, a polyoxyethylene fatty acid ester, or a combination of two or more thereof.

14. The composition of claim 1, wherein the ratio of surfactant to emulsion promoting agent, on a weight basis, is from about 1:200 to about 200:1.

15. The composition of claim 1, wherein the silicone resin is an organopolysiloxane selected from the group consisting of a MM, MDM, TD, MT, MDT, MDTQ, MQ, MDQ, and/or MTQ type resin, wherein: 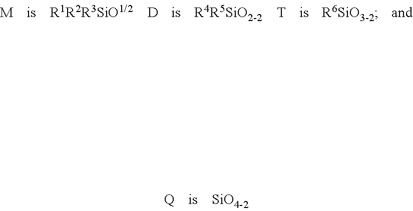
where R¹, R², R³, R⁴, R⁵, and R⁶ are each independently a substituted or an unsubstituted C₁-C30 monovalent hydrocarbon.

16. The composition of claim 15, wherein the silicone resin comprises from about 0 to about 50 percent by weight of an M unit; from about 0 to about 90 percent by weight of a D unit; from about 0 to 100 percent of a T unit; and from about 0 to about 60 percent by weight of a Q unit based on the weight of the organopolysiloxane.

17. The composition of claim 15, wherein the silicone resin is a DTQ type resin comprising from about 0.5 to about 60 percent by weight of a D unit, and from about 40 to about 99.5 percent by weight of a T unit; and from about 0.1 to about 30 percent by weight of a Q unit.

18. The composition of claim 15, wherein the silicone resin is a DT type resin comprising from about 5 to about 50 percent by weight of a D unit, and from about 50 to about 95 percent by weight of a T unit.

19. The composition of claim 15, wherein the silicone resin is a DT type resin comprising from about 15 to about 40 percent by weight of a D unit, and from about 60 to about 85 percent by weight of a T unit.

20. The composition of claim 15, wherein the silicone resin is T type resin comprising 100 percent by weight of a T unit.

21. The composition of claim 15, wherein the silicone resin comprises from about 5 to 40 percent by weight of a T unit of the formula CH₃SiO_{3/2} units, 0 to 35 percent by weight of a D unit of the formula (CH₃)₂SiO_{2/2} units, 15 to 65 percent by weight of a T unit of the formula (C₆H₅)SiO_{3/2}, and 0 to 50 percent by weight of a D unit of the formula (C₆H₅)SiO_{2/2} based on the weight of the polyorganosiloxane.

22. The composition of claim 15, wherein the silicone resin comprises from about 0.1 to about 50 percent by weight of a condensable group.

23. The composition of claim 15, wherein the silicone resin comprises from about 0.5 to about 20 percent by weight of a condensable group.

24. The composition of claim 15, wherein the silicone resin comprises from about 1 to about 7 percent by weight of a condensable group.

25. The composition of claim 1, wherein the condensable group is selected from OR¹⁶ or a divalent hydrocarbon radical, OR¹⁷O, where R¹⁶ is independently selected from H or a C1-C10 hydrocarbon radical and R¹⁷ is independently selected from C1-C10 divalent hydrocarbon radical.

26. The composition of claim 1 wherein the silicone resin is represented by the formula: 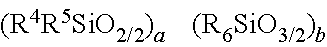
where R⁴, R⁵, and R⁶ are each independently a substituted or unsubstituted C1-C30 monovalent hydrocarbon; a≥0 and b≥1; a+b≥2.

27. The composition of claim 1, wherein the silicone resin comprises from about 1 to about 7 percent by weight of a condensable group.

28. The composition of claim 1, wherein the condensable group is selected from OR¹⁶ or a divalent hydrocarbon radical, OR¹⁷O, where R¹⁶ is independently selected from H or a C1-C10 hydrocarbon radical and R¹⁷ is independently selected from C1-C10 divalent hydrocarbon radical.

29. The composition of claim 1, wherein the composition is substantially free of a solvent other than water.

30. A coating comprising the composition of claim 1.

31. An article comprising the coating of claim 30 wherein the coating is disposed on a surface of the article.

32. A method of preparing an emulsion, the method comprising: contacting water, a surfactant, an emulsion promoting agent, and a silicone resin to form a mixture, and homogenizing the mixture to form an emulsion, wherein the emulsion promoting agent is selected from the group consisting of a hydrophobically modified polyether and a polyether derived copolymer, wherein the hydrophobically modified polyether has hydrophobic groups at both the terminals.

33. The method of claim 32, wherein forming the emulsion is carried out at a temperature of from about 20° C. to about 80° C.

34. A silicone emulsion prepared by method of claim 32.

35. The silicone emulsion in claim 34, wherein the emulsion is an oil-in-water emulsion.
